(19) United States
(12) Patent Application Publication
(10) Pub. No.: US 2012/0171959 A1
(43) Pub. Date: Jul. 5, 2012

(54) STORAGE DEVICE

(75) Inventor: Su-Fen Cheng, New Taipei City (TW)

(73) Assignee: DEUTRON ELECTRONICS CORP., Taipei City (TW)

(21) Appl. No.: 13/047,470

(22) Filed: Mar. 14, 2011

(30) Foreign Application Priority Data
Dec. 29, 2010 (TW) 099225409

(51) Int. Cl. H04B 7/00

(52) U.S. Cl. 455/41.2

(57) ABSTRACT

A storage device includes an access control module and a Bluetooth transmission module. The storage device can control a data access right through a mobile device performing authentication. After receiving a start signal, the Bluetooth transmission module searches for a mobile device, and permits access to the access control module according to a Bluetooth position and pairing data.

### CROSS-REFERENCE TO RELATED APPLICATIONS

This non-provisional application claims priority under 35 U.S.C. §119(a) on Patent Application No(s). 099225409 filed in Taiwan, R.O.C. on Dec. 29, 2010, the entire contents of which are hereby incorporated by reference.

### BACKGROUND OF THE INVENTION

1. Field of Invention

The present invention relates to a storage device, and more particularly to a storage device with a security function.

2. Related Art

Flash drives have brought about a revolution of the data storage manner. A flash memory may be used in a Universal Serial Bus (USB) interface, a compact flash (CF) card interface or a Secure Digital (SD) card interface. Documents and multimedia files such as images and music can both be stored in the flash drive.

However, if digital data stored in the flash drive is not protected in a particular manner, the digital data may be easily copied or stolen. Especially for business people, the digital data is important. Therefore, a security feature of the flash drive is of great importance.

In most conventional security manners, a user inputs a password through a keyboard, so as to be authenticated, and therefore data privacy is protected. However, the users generally use more than one digital product, each user has to remember multiple passwords in order to protect data, and as a result, it becomes complicated for the user to remember the passwords. Moreover, when the password is used for protecting the data, the password may still be cracked by people with malicious intentions. That is to say, even though the password is used for encryption, the data security is still at stake.

In another aspect, the prior art also proposes the use of biological features such as fingerprint identification for encryption and decryption. Although the fingerprint identification achieves higher security than the password, complex identification equipment is required for the fingerprint identification. Therefore, the flash drive with fingerprint encryption and decryption functions will have a high cost.

### SUMMARY OF THE INVENTION

Accordingly, the present invention is a storage device. The storage device is electrically connected to a host and is wirelessly connected to a Bluetooth master device. The storage device comprises an access control module and a Bluetooth transmission module.

The access control module comprises a memory, a transmission interface and a data controller. The memory is used for storing digital data. The transmission interface is connected to the host. The data controller is connected to the memory and the transmission interface. When the data controller is started, the data controller transmits the digital data to the host through the transmission interface.

The Bluetooth transmission module comprises a Bluetooth transmitter, a Bluetooth memory and a Bluetooth controller. After receiving a start signal, the Bluetooth transmitter is wirelessly connected to the Bluetooth master device and obtains a Bluetooth position of the Bluetooth master device. The Bluetooth memory stores pairing data; the Bluetooth controller transmits a permission signal to the data controller according to the Bluetooth position and the pairing data. The data controller permits access to the memory.

The storage device may be plugged to the host to search for a paired mobile device, and the data in the storage device cannot be accessed unless the authentication is passed, thereby achieving a data security function.

### BRIEF DESCRIPTION OF THE DRAWINGS

FIG. 1 is a schematic block diagram of a first embodiment;

FIG. 2 is a schematic block diagram of a second embodiment;

FIG. 3 is a schematic block diagram of a third embodiment;

FIG. 4 is a flow chart of an initial setting process;

FIG. 5 is a flow chart of a data security process; and

FIG. 6 is a flow chart of an anti-loss alarm process.

### DETAILED DESCRIPTION OF THE INVENTION

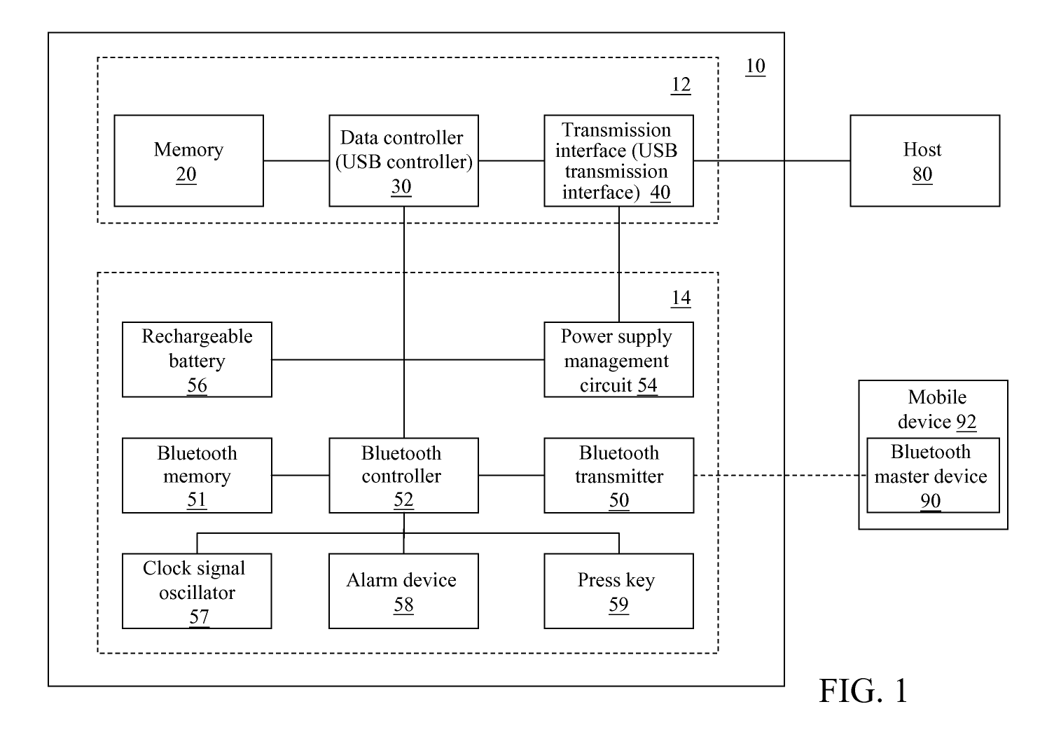

Refer to FIG. 1. A storage device 10 according to the present invention comprises an access control module 12 and a Bluetooth transmission module 14. The storage device 10 may be a USB flash drive, and the storage device 10 may be electrically connected to a host 80. The storage device 10 is wirelessly connected to a Bluetooth master device 90. After the storage device 10 validates the Bluetooth master device 90, the host 80 may control an access right (permit access or forbid access) to digital data in the storage device 10.

The host 80 may be a device actively accessing the digital data in the storage device 10, for example, a personal computer, a notebook computer, a digital camera, a mobile phone, a digital frame or a walkman.

The Bluetooth master device 90 has a transmission function complying with a Bluetooth communication protocol. The Bluetooth master device 90 may be disposed in a mobile device 92, and the mobile device 92 may be a mobile phone or a notebook computer. The Bluetooth master device 90 may also be disposed in the host 80 (the Bluetooth master device 90 and the host 80 are in the same device), or the Bluetooth master device 90 may be disposed in a device other than the host 80 (the Bluetooth master device 90 and the host 80 are two different devices).

The access control module 12 comprises a memory 20, a data controller 30 and a transmission interface 40.

The memory 20 may be a flash memory. The memory 20 has multiple storage areas and may store the digital data.

The data controller 30 is connected to the memory 20. The data controller 30 is a USB controller. The data controller 30 may compile the digital data into a packet with a format complying with a data transmission standard, and gives a particular address to the packet according to a destination of the digital data. Only when the data controller 30 is started, the memory 20 can be written or read.

The transmission interface 40 is connected to the data controller 30, and may be connected to a slot corresponding to the host 80. The transmission interface 40 may transmit the packet compiled by the data controller 30 to the host 80 through an electric signal. In addition, the transmission interface 40 may also receive an external power supply transmitted by the host 80. In this embodiment, the transmission interface 40 may be a USB transmission interface.

The Bluetooth transmission module 14 comprises a Bluetooth transmitter 50, a Bluetooth memory 51, a Bluetooth controller 52, a power supply management circuit 54, a rechargeable battery 56, a clock signal oscillator 57, an alarm device 58 and a press key 59.

The Bluetooth transmitter 50 has a transmission function complying with a Bluetooth communication protocol, and the Bluetooth transmitter 50 may be connected to the Bluetooth master device 90. The Bluetooth transmitter 50 searches for the Bluetooth master device 90 in a certain distance, and pairs with the found Bluetooth master device 90. The Bluetooth memory 51 may store a key and pairing data. The Bluetooth controller 52 can judge whether the Bluetooth master device 90 has a particular authority according to the key and pairing data.

The power supply management circuit 54 is electrically connected to the transmission interface 40 and the rechargeable battery 56. The power supply management circuit 54 may convert the external power supply received by the transmission interface 40 or an internal power supply stored by the rechargeable battery 56 into a proper voltage for supply to the Bluetooth controller 52. The power supply management circuit 54 may also convert the external power supply provided by the transmission interface 40 to charge the rechargeable battery 56. When the rechargeable battery 56 is fully charged, the power supply management circuit 54 automatically switches the charging loop to a maintenance mode. When the voltage of the rechargeable battery 56 is lower than a set operating range voltage, the power supply management circuit 54 provides information to the Bluetooth master device 90, so as to use the alarm device 58 to alarm.

The clock signal oscillator 57 has an oscillating circuit. The oscillating circuit can provide a stable clock signal to the Bluetooth controller 52. Upon receiving the clock signal, the Bluetooth controller 52 starts operating.

The alarm device 58 is electrically connected to the Bluetooth controller 52. The alarm device 58 may comprise a buzzer. The buzzer may emit a sound to alarm. The alarm device 58 may also comprise at least one light emitting diode (LED), and the LED may emit light or flash to alarm.

The press key 59 is electrically connected to the Bluetooth controller 52, and the press key 59 may be a power switch, or may be multiple press keys, for the user to operate and use.

In normal use, the Bluetooth transmitter 50 may be in a standby mode, so as to save power consumption. When the Bluetooth transmitter 50 is in the standby mode, the Bluetooth controller 52 transmits a limiting signal to the data controller 30, such that access to the digital data in the memory 20 is forbidden.

The Bluetooth controller 52 may be electrically connected to a power pin of the data controller 30. When the Bluetooth controller 52 transmits the limiting signal to the data controller 30, the Bluetooth controller 52 may cut off a power input of the data controller 30. At this time, the data controller 30 cannot operate normally, and therefore access to the digital data in the memory 20 is forbidden.

In another aspect, a switch may be disposed in a data link path between the data controller 30 and the memory 20. The Bluetooth controller 52 may transmit the limiting signal to cut off the switch, so as to cut the data link path between the data controller 30 and the memory 20. Therefore, access to the digital data in the memory 20 is forbidden.

That is to say, in normal use, the user cannot obtain the digital data in the memory 20.

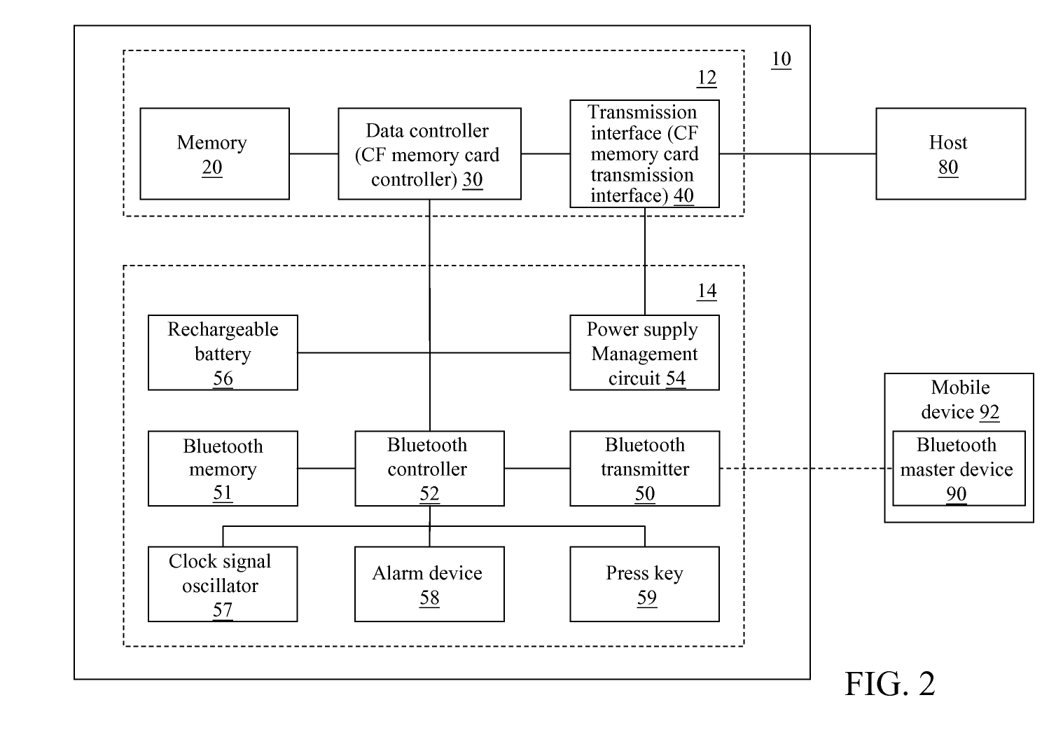

Refer to FIG. 2. A storage device 10 comprises an access control module 12 and a Bluetooth transmission module 14. The storage device 10 may be a CF memory card.

A data controller 30 is a CF memory card controller. A transmission interface 40 may be a CF memory card transmission interface.

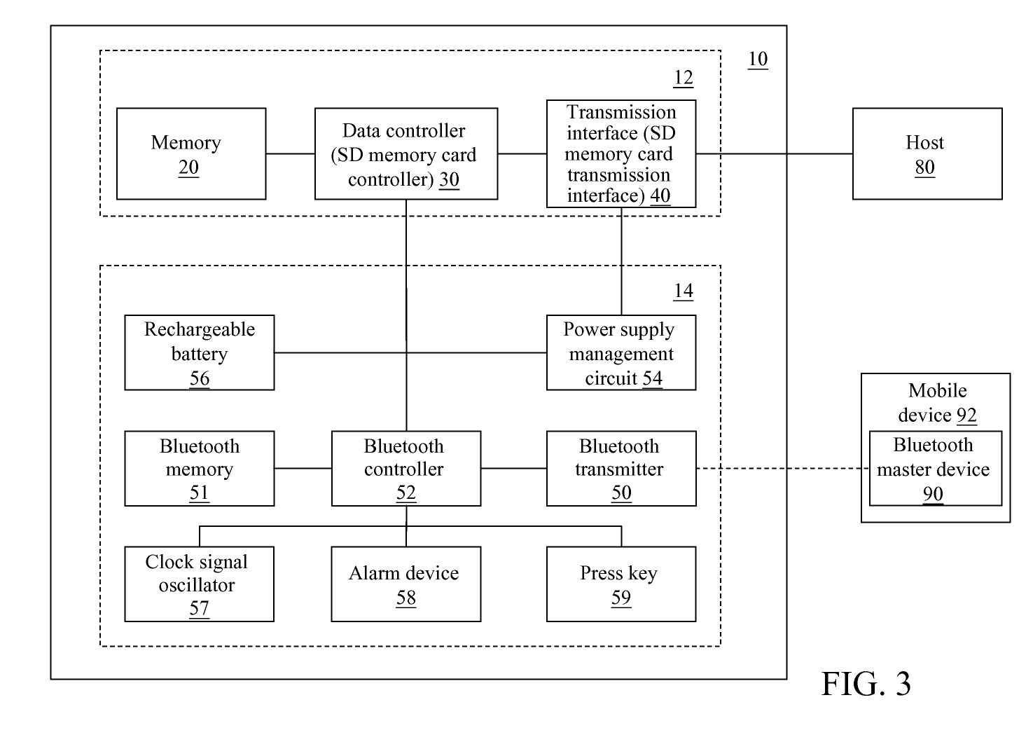

Refer to FIG. 3. A storage device 10 comprises an access control module 12 and a Bluetooth transmission module 14. The storage device 10 may be an SD memory card.

A data controller 30 is an SD memory card controller. A transmission interface 40 may be an SD memory card transmission interface. The Bluetooth transmission module 14 is similar to that of FIG. 1.

The above is hardware architecture of the storage device 10 according to the present invention. The storage device 10 can realize effects of data security and anti-loss alarm by using the same hardware architecture. The procedure performed by the storage device 10 may be divided into an initial setting process, a data security process and an anti-loss alarm process. Detailed steps of these processes are described as follows.

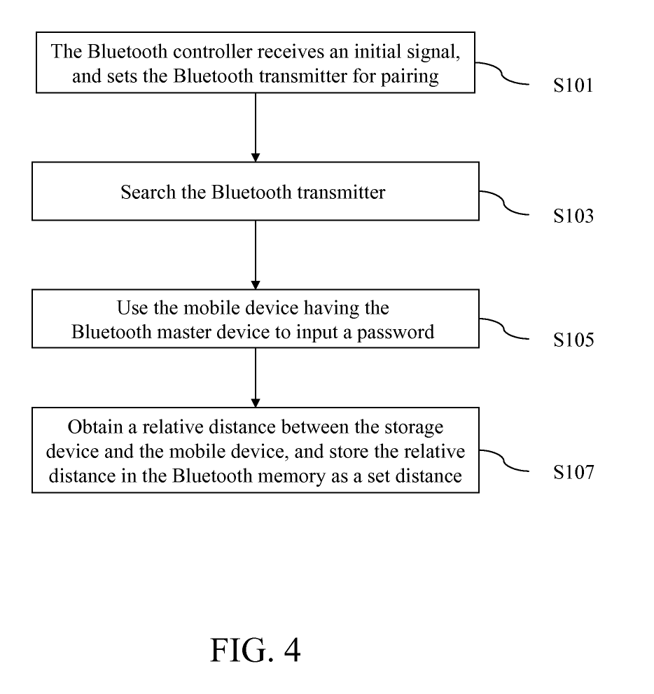

Refer to FIG. 4. In Step S101, after a user presses the press key 59 (for example, a RESET key), the Bluetooth controller 52 receives an initial signal. At this time, the Bluetooth controller 52 sets the storage device 10 to enter an initial state. Moreover, the Bluetooth controller 520 sets the Bluetooth transmitter 50 for pairing.

In Step S103, the user uses the mobile device 92 having the Bluetooth master device 90 to search for the Bluetooth transmitter 50.

In Step S105, when the Bluetooth master device 90 searches for the Bluetooth transmitter 50, the user uses the mobile device 92 having the Bluetooth master device 90 to input a password. Each storage device 10 is only corresponding to a unique password. That is to say, the user has to keep the password, so as to use the Bluetooth master device 90 to pair with the Bluetooth transmitter 50 in the storage device 10.

The Bluetooth master device 90 transmits the password to the Bluetooth transmitter 50. The Bluetooth transmitter 50 compares the password with the key stored in the Bluetooth memory 51 through the Bluetooth controller 52. When the comparison is passed, the Bluetooth controller 52 stores pairing data in the Bluetooth memory 51. The pairing data may comprise a Bluetooth address corresponding to the Bluetooth master device 90.

In Step S107, the user may change a relative distance between the storage device 10 and the mobile device 92. The relative distance should be smaller than a communication distance of the Bluetooth transmitter 50, so as to maintain the communication between the Bluetooth transmitter 50 and the Bluetooth master device 90. Afterwards, the user may press the press key 59 (for example, a set key), and the Bluetooth transmitter 50 may obtain the relative distance between the storage device 10 and the mobile device 92 according to a Bluetooth transmission signal. The Bluetooth controller 52 may store the relative distance in the Bluetooth memory 51, so as to use the relative distance as a set distance.

Step S107 may be repeated. The user may press the press key (set key) at any time to obtain and store the relative distance between the storage device 10 and the mobile device 92.

In another aspect, Step S107 may be an unnecessary step. A preset distance may be pre-stored in the Bluetooth memory 51. If the user does not press the set key to obtain the relative distance, the storage device 10 may use the pre-set distance as the set distance.

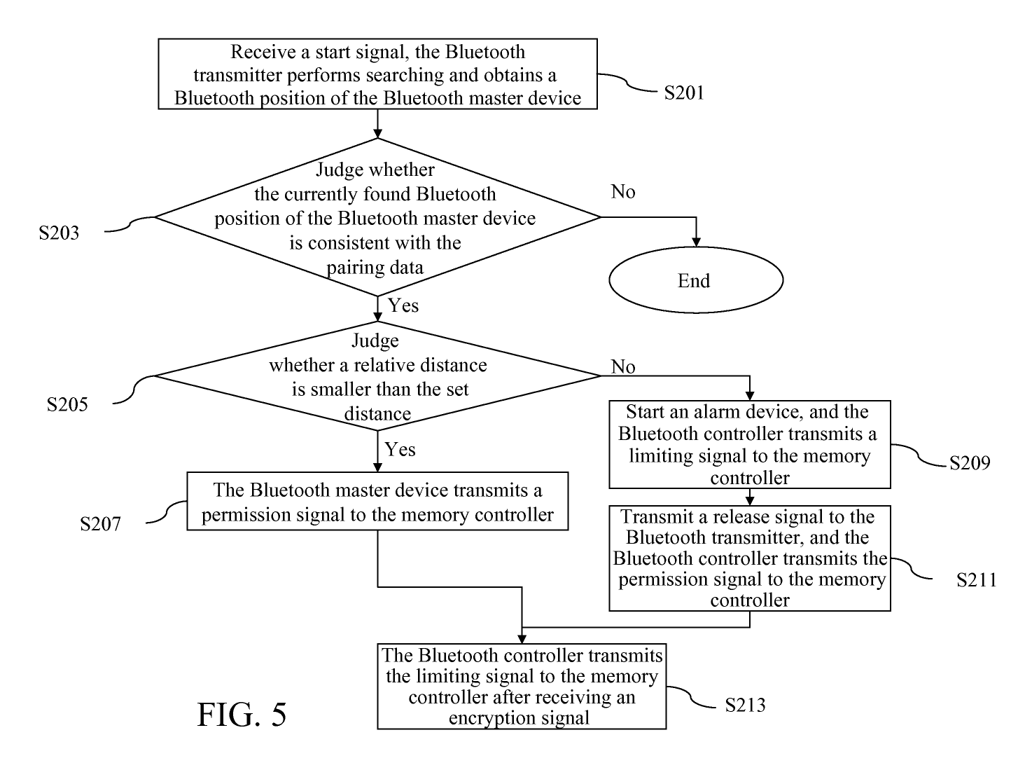

Refer to FIG. 5. In Step S201, after receiving a start signal, the Bluetooth controller 52 controls the Bluetooth transmitter 50 to switch from the original standby state to an operating state, and controls the Bluetooth transmitter 50 to perform searching. After finding the Bluetooth master device 90, the Bluetooth transmitter 50 can obtain a Bluetooth position of the Bluetooth master device 90.

The start signal may be generated when the user presses the press key 59 (for example, a start key) and the Bluetooth controller 52 detects that the press key 59 is pressed.

In another aspect, when the transmission interface 40 is connected to the slot corresponding to the host 80, the transmission interface 40 receives an external power supply transmitted by the host 80. The data controller 30 detects the external power supply and transmits a power supply detecting signal. The Bluetooth controller 52 generates the start signal in response to the power supply detecting signal.

In Step S203, the Bluetooth controller 52 judges whether the currently found Bluetooth master device 90 is the same as the Bluetooth master device 90 paired in the initial setting process according to a currently obtained Bluetooth position and the Bluetooth position in the pairing data.

If a judgment result in Step S203 is no, it represents that the found Bluetooth master device 90 is not the Bluetooth master device 90 paired in the initial setting process. Therefore, the Bluetooth transmitter 50 is switched to the standby state, and the data security process is ended.

If the judgment result in Step S203 is yes, it represents that the found Bluetooth master device 90 is the same as the Bluetooth master device 90 paired in the initial setting process. At this time, Step S205 is performed.

In Step S205, the Bluetooth transmitter 50 obtains a relative distance between the storage device 10 and the mobile device 92 according to a Bluetooth transmission signal. Then, the Bluetooth controller 52 judges whether the relative distance is smaller than the set distance stored in the Bluetooth memory 51 according to the relative distance and the set distance.

If a judgment result is yes, Step S207 is performed. In Step S207, the Bluetooth controller 52 transmits a permission signal to the data controller 30, so as to permit access to the digital data in the memory 20.

Step S205 may be repeated periodically, so as to judge whether the relative distance is smaller than the set distance. If the judgment result is no, Step S209 is performed.

In Step S209, when it is judged that the relative distance between the storage device 10 and the mobile device 92 is greater than the set distance, it represents that the mobile device 92 has moved away from the storage device 10. The Bluetooth controller 52 enters an alarm state, and the Bluetooth controller 52 starts the alarm device 58 to emit a sound or light to alarm. At this time, the Bluetooth controller 52 transmits a limiting signal to the data controller 30, such that access to the digital data in the memory 20 is forbidden.

In Step S211, when the Bluetooth controller 52 enters the alarm state, the user inputs a particular release number through the mobile device 92, and transmits a release signal to the Bluetooth transmitter 50 through the Bluetooth master device 90. The Bluetooth controller 52 then can release the alarm state, and the Bluetooth controller 52 transmits the permission signal to the data controller 30, such that the digital data in the memory 20 can be accessed. Moreover, the Bluetooth controller 52 stops emitting the sound or light.

Moreover, after Step S207 and Step S211, that is, when the digital data in the memory 20 can be accessed, Step S213 may be performed to control the storage device 10, such that the storage device 10 cannot be read or written.

In Step S213, the user may input a particular security number through the mobile device 92, and transmits an encryption signal to the Bluetooth transmitter 50 through the Bluetooth master device 90. After receiving the encryption signal, the Bluetooth controller 52 transmits the limiting signal to the data controller 30, such that access to the digital data in the memory 20 is forbidden for the moment.

Through the above process, access to the digital data in the memory 20 can be permitted or forbidden by interaction between the storage device 10 and the mobile device 92, thereby achieving the data security effect.

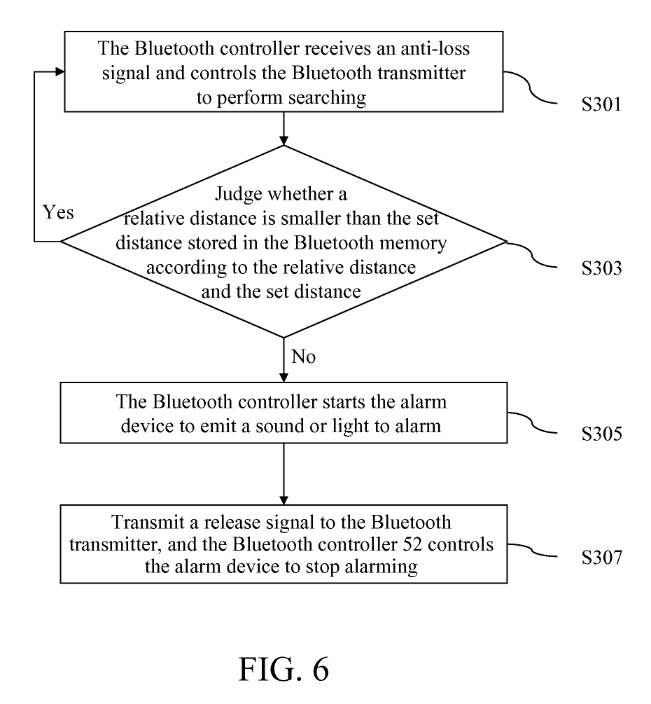

Refer to FIG. 6. After the initial setting process is completed, the anti-loss alarm process can be performed.

In Step S301, the user may press the press key 59 (for example, an anti-loss key), and the Bluetooth controller 52 controls the Bluetooth transmitter 50 to switch from the original standby state to the operating state, and controls the Bluetooth transmitter 50 to perform searching.

In Step S303, after finishing searching, the Bluetooth transmitter 50 obtains a relative distance between the storage device 10 and the mobile device 92 according to a Bluetooth transmission signal. Then, the Bluetooth controller 52 judges whether the relative distance is smaller than the set distance stored in the Bluetooth memory 51 according to the relative distance and the set distance. If a judgment result is yes, Step S305 is performed.

In Step S305, when it is judged that the relative distance between the storage device 10 and the mobile device 92 is greater than the set distance, the Bluetooth controller 52 enters an alarm state. The Bluetooth controller 52 starts the alarm device 58 to emit a sound or light to alarm, so as to reduce the possibility that the user loses the mobile device 92.

In Step S307, when the Bluetooth controller 52 enters the alarm state, the user inputs a particular release number through the mobile device 92, and transmits a release signal to the Bluetooth transmitter 50 through the Bluetooth master device 90. The Bluetooth controller 52 controls the alarm device 58 to stop emitting the sound or light, so as to release the alarm function.

Through the above hardware architecture and the processes, when plugged to the host 80, the storage device 10 can automatically search for the paired mobile device 92, and the digital data in the storage device 10 cannot be accessed unless the authentication is passed. The user may set a detection distance, such that when the distance between the mobile device 92 and the storage device 10 is greater than the set value of the user, the digital data in the storage device 10 cannot be accessed. Moreover, when the anti-loss function of the storage device 10 is enabled and the distance between the mobile device 92 and the storage device 10 is greater than the set value, the storage device 10 alarms to prevent the user from losing the mobile device 92.

What is claimed is:

1. A storage device, electrically connected to a host and wirelessly connected to a Bluetooth master device, the storage device comprising:
an access control module, comprising:
a memory, storing digital data;
a transmission interface, connected to the host; and
a data controller, connected to the memory and the transmission interface; and
a Bluetooth transmission module, comprising:
a Bluetooth transmitter, wherein after receiving a start signal, the Bluetooth transmitter is wirelessly connected to the Bluetooth master device and obtains a Bluetooth position of the Bluetooth master device;
a Bluetooth memory, storing pairing data; and
a Bluetooth controller, for transmitting a permission signal to the data controller according to the Bluetooth position and the pairing data to start the data controller, wherein the data controller transmits the digital data to the host through the transmission interface, such that access to the memory is permitted.

2. The storage device according to claim 1, wherein the transmission interface receives an external power supply transmitted by the host, the data controller transmits a power supply detecting signal to the Bluetooth controller when detecting the external power supply, and the Bluetooth controller generates the start signal in response to the power supply detecting signal.

3. The storage device according to claim 1, wherein the Bluetooth transmission module comprises a press key, the press key is connected to the Bluetooth controller, and the Bluetooth controller generates the start signal when detecting that the press key is pressed.

4. The storage device according to claim 1, wherein the Bluetooth controller is electrically connected to a power pin of the data controller, and when the Bluetooth transmitter is in a standby mode, the Bluetooth controller transmits a limiting signal to the data controller, so as to cut off a power input of the data controller, such that access to the memory is forbidden.

5. The storage device according to claim 1, wherein when the Bluetooth controller receives an initial signal, the Bluetooth transmitter obtains a relative distance between the storage device and the Bluetooth master device, and the Bluetooth controller stores the relative distance in the Bluetooth memory as a set distance.

6. The storage device according to claim 5, wherein the Bluetooth transmitter obtains the relative distance between the storage device and the Bluetooth master device, and when the Bluetooth controller judges that the relative distance is greater than the set distance, the Bluetooth controller transmits a limiting signal to the data controller, such that access to the memory is forbidden.

7. The storage device according to claim 6, wherein the Bluetooth transmitter comprises an alarm device, and when the Bluetooth controller judges that the relative distance is greater than the set distance, the Bluetooth controller starts the alarm device to alarm.

8. The storage device according to claim 7, wherein when the Bluetooth transmitter receives a release signal from the Bluetooth master device, the Bluetooth controller transmits the permission signal to the data controller, so as to permit access to the memory.

9. The storage device according to claim 1, wherein when the Bluetooth transmitter receives an encryption signal from the Bluetooth master device, the Bluetooth controller transmits a limiting signal to the data controller, such that access to the memory is forbidden.

10. The storage device according to claim 1, wherein the Bluetooth master device is disposed in the host.
